(19) United States
(12) Patent Application Publication
(10) Pub. No.: US 2003/0079354 A1
(43) Pub. Date: May 1, 2003

(54) Compass

(76) Inventors: Mark A. McLean, Wausau, WI (US); Victor J. Burmeister, Schofield, WI (US); Sean Petersen, Cross Plains, WI (US); Kyle M. Bennett, Wausau, WI (US)

Correspondence Address: Marshall J. Brown, Foley & Lardner, Suite 3300, 330 North Wabash Avenue, Chicago, IL, 60611-3608, US

(21) Appl. No.: 10/000,717

(22) Filed: Oct. 31, 2001

(51) Int. Cl. B43L 9/02

(52) U.S. Cl. 33/27.033

(57) ABSTRACT

A compass, comprising a head portion and first and second leg members. Each of the first and second leg members include a first end and a second end, the first end of the first leg member and the first end of the second leg members are rotatably engaged with the head portion at different locations on the head portion. A post member is meshedly engaged with the first end of the first and second leg members, and an adjusting wheel is threadedly engaged with the post member. The rotation of the adjusting member results in a corresponding movement in the post member. The movement of the post member causes a rotation of the first end of the first leg member relative to the second leg member.

### FIELD OF THE INVENTION

The present invention relates generally to marking devices. More particularly, the present invention relates to a compass for describing an arc of a substantially constant radius.

### BACKGROUND OF THE INVENTION

Devices for describing arcs are conventionally known. Such devices often are referred to as compasses and include two legs pivotably attached at one end. The free ends of the legs can be pivoted towards or away from one another. By attaching a marking instrument, such as a pencil, to one leg and holding the other leg at a fixed point, the marking instrument can be rotated about the pivot point to form an arc of a substantially constant radius.

Many types of compasses, particularly those designed for student use, are marketed in a relatively low price range. For this reason, it has become increasingly important that reasonably priced compasses be manufactured at as low a cost as possible. Closely related to the manufacturing costs is the complexity of the components; as a general rule, the manufacturing costs increase with an increased number of components. Additionally, compasses designed for students of elementary-school age must be extremely simple to use or else the product will not gain wide acceptance with this group. Lastly, it is also important that the compass be relatively robust. This is especially important when young children are using the compass due to the increased likelihood of the compass being broken and/or misused.

### SUMMARY OF THE INVENTION

It is therefore an object of the invention to provide an improved device for describing arcs which is simple to use.

It is another object of the invention to provide an improved device for describing arcs which is relatively simple to manufacture.

It is yet another object of the invention to provide an improved device for describing arcs which is relatively inexpensive to manufacture.

It is another object of the invention to provide an improved device for describing arcs which is relatively robust in design.

It is still another object of the invention to provide a marking device that includes an adjusting member that is rotatable about an axis substantially perpendicular to a marking surface instead of substantially parallel to it.

Further advantages and features of the present invention will be apparent from the following specification and claims illustrating the preferred embodiments of the present invention.

### BRIEF DESCRIPTION OF THE DRAWINGS

FIG. 1 is a perspective view of a compass in a first position according to the present invention;

FIG. 2 is a perspective view of the compass of FIG. 1 in a second, open position;

FIG. 3 is an exploded view of the individual components of the compass of FIG. 1;

FIG. 4 is a side view of the compass of FIG. 1;

FIG. 5 is a sectional side view taken along lines 5-5 of FIG. 1;

FIG. 6 is magnified sectional view from FIG. 5 of the interaction of the upper portion of the threaded post and the adjusting wheel;

FIG. 7 is a perspective view of the collar coupled to the first leg member;

FIG. 8 is a perspective view of the adjusting wheel;

FIG. 9 is a perspective view of the tension ring; and

FIG. 10 is a magnified sectional view showing the interaction of the lower portion of the threaded post and the gear teeth of the second leg member.

### DETAILED DESCRIPTION OF PREFERRED EMBODIMENTS

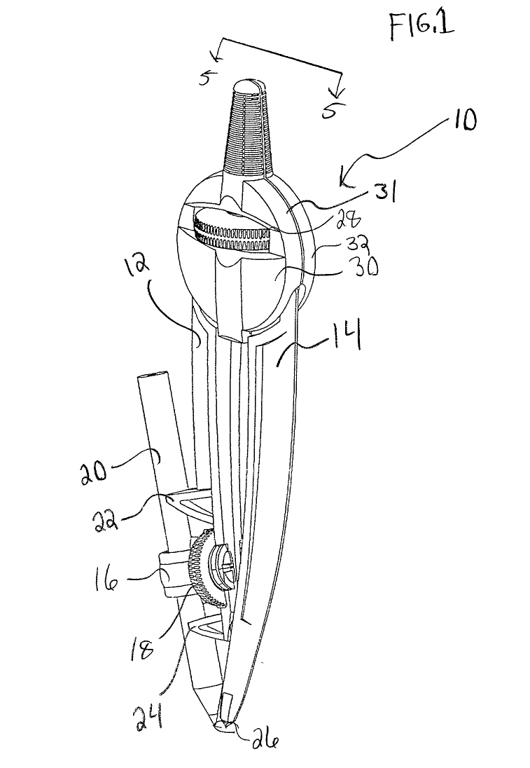

A compass 10 constructed in accordance with the invention is generally shown in FIGS. 1, 2 and 4. The compass 10 includes a first leg member 12 and a second leg member 14. The first leg member 12 includes a collar 16 which is secured to the first leg member 12 by a tension ring 18. The collar 16 includes a region in the center thereof for positioning of a marking instrument 20 such as a pencil. The first leg member 12 also includes a first positioner 22 and a second positioner 24. The first positioner 22 and the second positioner 24 are used to maintain the marking instrument 20 in a relatively constant position relative to the first leg member 12. The second leg member 14 includes a tip member 26 at one end thereof. The tip member 26, which can be formed as a single piece with the second leg member 14 or as a second component, is used to firmly position the second leg member 14 relative to a marking surface such as a piece of paper. The tip member 26 may also possess frictional material or structural characteristics in order to prevent the tip member 26 from moving relative to the marking surface.

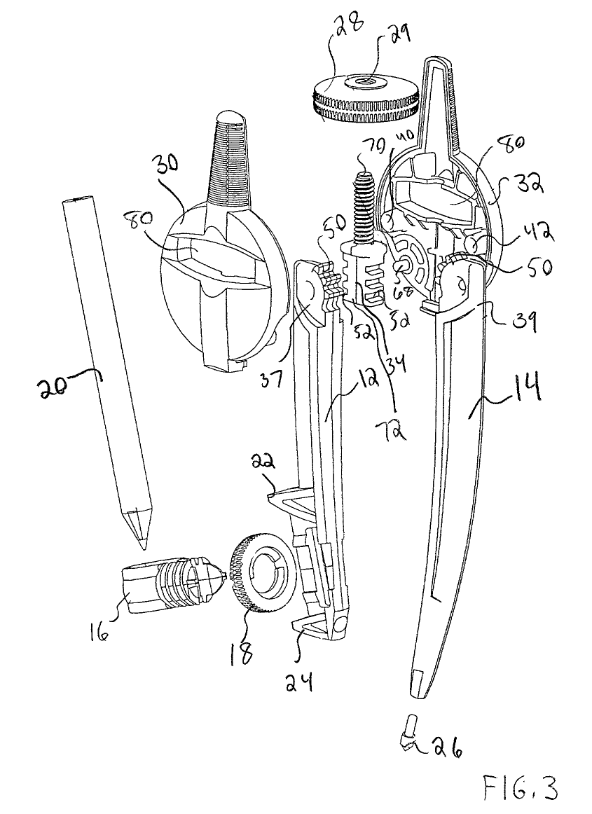

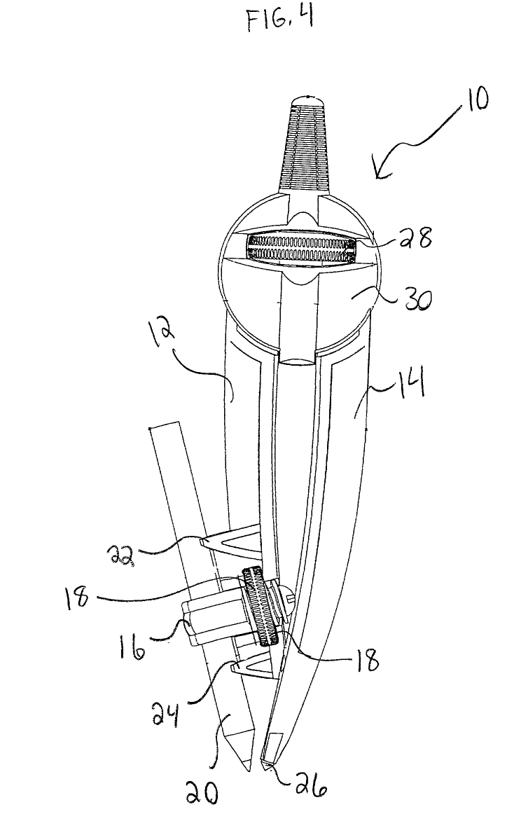

As shown in FIG. 3, the first leg member 12 and the second leg member 14 are each coupled to a pivot head 31. According to one embodiment of the invention, the pivot head 31 comprises a first head half 30 and a second head half 32 which are coupled to each other by one of a variety of conventionally known means. According to one particular embodiment of the invention the first head half 30 includes a plurality of pins (not shown) that mate with a first recess 40 and a second recess 42 in the second head half 32, as shown in FIGS. 3 and 5. As shown in FIG. 5, an upper portion 37 of the first leg member 12 is coupled to the second head half 32 at a pivot point 36. Similarly, an upper portion 39 of the second leg member 14 is coupled to the second head half 32 at a second pivot point 38. A variety of connecting means, such as pins 68 shown in FIG. 3, may be used to couple the first leg member 12 and the second leg member 14 to the second head half 32. It is also possible to couple the first leg member 12 and the second leg member 14 to the first head half 30 instead of the second head half 32.

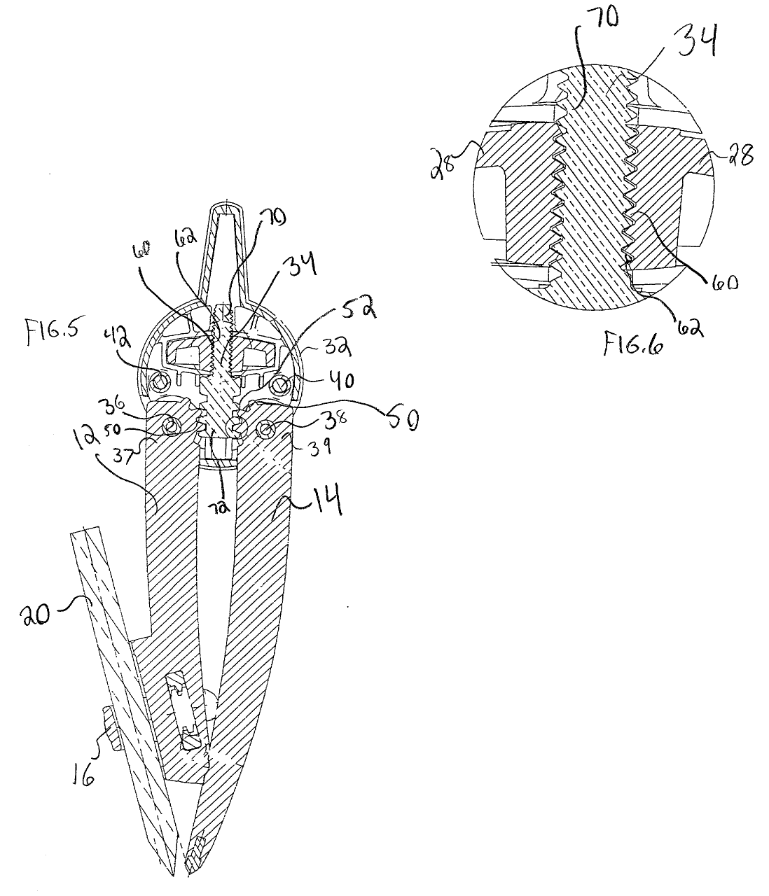

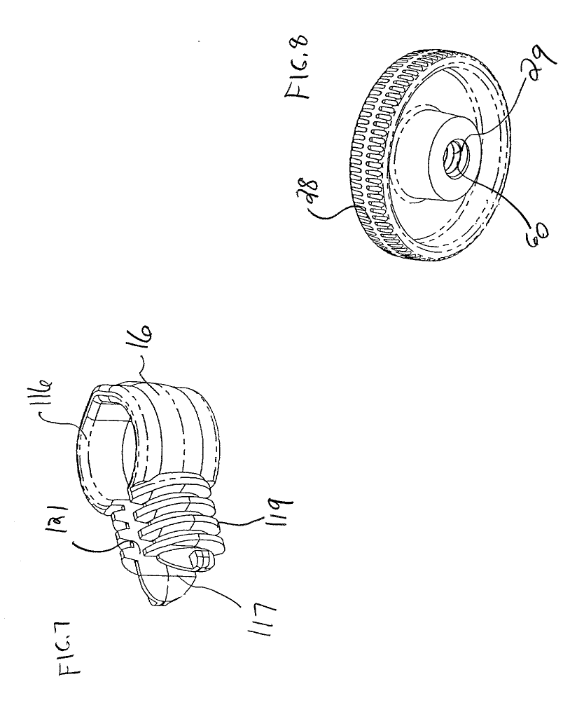

As can be clearly seen in FIGS. 5 and 6, a threaded post 34 is located between the first head half 30 and the second head half 32 and is substantially surrounded at one portion thereof by the adjusting wheel 28. The adjusting wheel 28 is located within a slot 80 included in both the first head half 30 and the second head half 32. The threaded post 34 includes an upper portion 70 and a lower portion 72. The upper portion 70 includes a plurality of threads 62 in at least the region surrounded by the adjusting wheel 28. The adjusting wheel 28, as shown in FIGS. 3 and 8, includes a central bore 29 and wheel threads 60 located on the inner surface that defines the bore 29 threadedly engaging the threaded post 34. As shown in FIGS. 3, 5 and 10, the upper portion 37 of the first leg member 12 include a plurality of gear teeth 50. Similar gear teeth 50 are also found at the upper portion 39 of the second leg member 14. The gear teeth 50 interact with a plurality of notches 52 which are located at the lower portion 72 of the threaded posts 34.

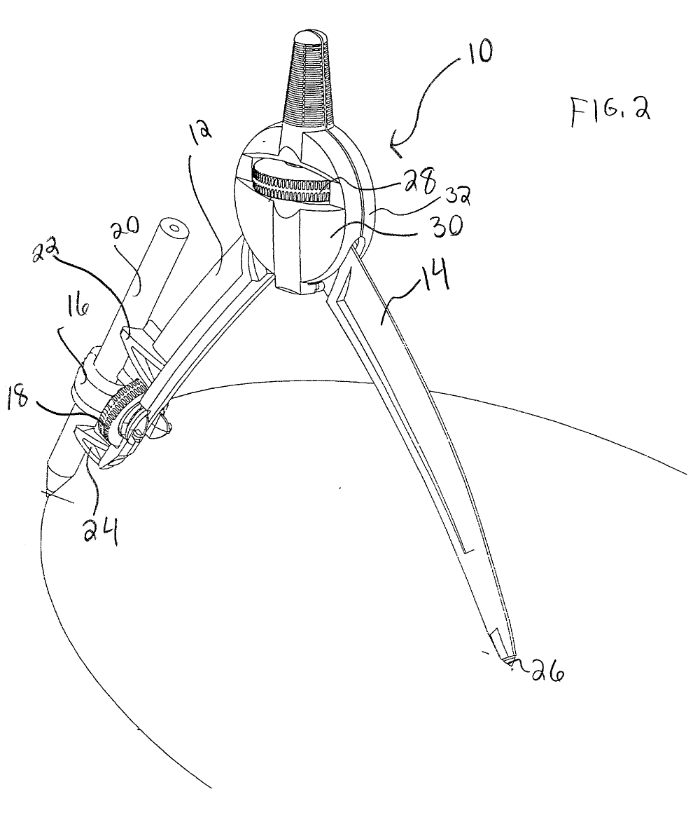

When a user desires to adjust the position of the first leg member 12 and the second leg member 14 relative to each other, such as from the position disclosed in FIG. 1 to the position disclosed in FIG. 2, the user performs the following steps: Depending upon the particular arrangement of the threads 62 on the upper portion 70 of the threaded posts 34, the user rotates the adjusting wheel 28 in a first direction. In one particular embodiment of the invention, the user rotates the adjusting wheel 28 in a clockwise direction about an axis substantially perpendicular to the marking surface. Unlike many conventional compasses, the marking device 10 of the present invention has the adjusting wheel 28 rotatable about an axis substantially perpendicular to the marking surface instead of substantially parallel to it. As the height of the adjusting wheel 28 relative to the marking surface is maintained relatively constant due to the constrainment of the slot 80 in which the adjusting wheel 28 is located, the counter-clockwise rotation of the adjusting wheel 28 causes the threaded post 34 to move in a downward direction along the axis of rotation of the adjusting wheel 28. This downward movement of the threaded post 34 is due primarily to the interaction between the corresponding threads 62 of the threaded posts 34 and the threads 60 of the adjusting wheel 28. The interaction between the adjusting wheel 28 and the threaded post 34 can be seen more clearly in FIG. 6.

When the threaded post 34 moves downward relative to the position of the adjusting wheel 28, an additional interaction occurs between the threaded post 34 and the first leg member 12 and the second leg member 14. As previously discussed, the gear teeth 50 of the first leg member 12 and the second leg member 14 are in substantially constant engagement with the notches 52 of the lower portion 72 of the threaded post 34. This mating engagement feature can be seen more clearly in FIG. 10. As shown in FIG. 5 the threaded post 34 moves downward, this mating engagement results in a gearing action in which the downward motion of the notches 52 causes a rotation of the gear teeth 50 on both the first leg member 12 and second leg member 14. The rotation of the gear teeth 50 of the first leg member 12 occurs in a substantially opposite direction as the gear teeth 50 of the second leg member 14. For example, as shown in the preferred embodiment of FIG. 5, the gear teeth 50, as well as the entire upper portion 37 of the first leg member 12, will rotate in a clockwise direction, while the gear teeth 50 and the upper portion 39 of the second leg member 14 will rotate in a substantially counterclockwise direction. This rotation in opposite directions of the upper portions 37 and 39 of the first leg member 12 and the second leg member 14 causes the first leg member 12 and the second leg member 14 to move away from each other. This movement allows the user to define an arc having a substantially increased radius.

In the event that the user desires to decrease the radius of an arc to be described, the user simply follows a substantially opposite procedure. Considering the embodiment shown in FIG. 5 as a guide, the user rotates the adjusting wheel 28 in a substantially clockwise direction about the axis perpendicular to the marking surface. The interaction between the adjusting wheel 28 and the threaded post 34 causes the threaded post 34 to move upward relative to the marking surface. This upward movement of the threaded post 34 results in the upper portion 37 of the first leg member 12 to rotate in a substantially counterclockwise direction while the upper portion 39 of the second leg member 14 moves in a substantially counterclockwise direction. This causes the marking device 10 to move from the position shown in FIG. 2 towards the position shown in FIG. 1.

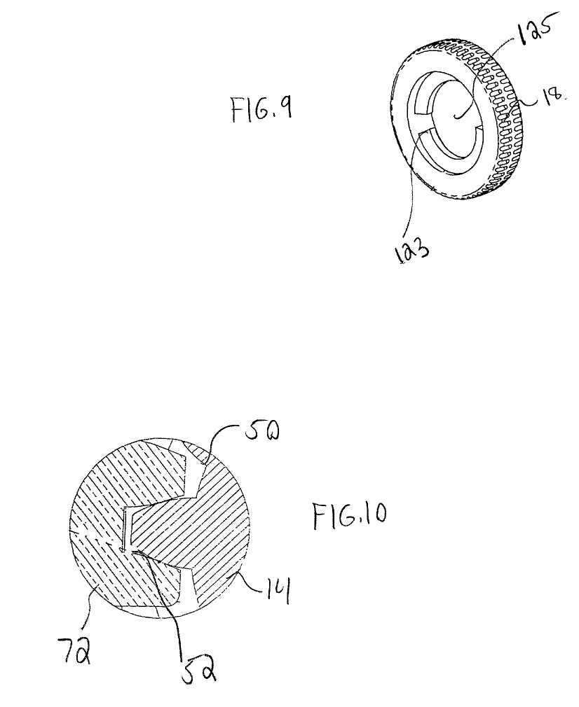

As previously discussed, the marking device 10 also includes a collar 16 which is substantially surrounded at one portion by a tension ring 18. The collar 16 is more clearly shown in FIG. 7, while the tension ring 18 is more clearly shown in FIG. 9. The collar 16 includes a circular portion 116 and a connecting portion 117 which includes a plurality of threads 119. A slot 121 is positioned within the connecting portion 117. The slot 121 permits a portion of the first leg member 12 to pass into the middle of the collar 16.

Once the first leg member 12 is positioned partially within the collar 16, the tension ring 18 is fitted on the connecting portion 117 of the collar 16. In one embodiment of the invention, the tension ring 18 in FIG. 9 includes a singular thread 123 on an inner surface of the tension ring 18. The inner surface defines a bore 121 substantially through the center of the tension ring 18. The singular thread 123 threadedly engages the threads 119 on the connecting portion 117 of the collar 16 (see FIG. 8).

When a user desires to place the marking instrument 20 inside the collar 16, the user rotates the tension ring 18 in FIG. 9. As a result of the threaded engagement between the tension ring 18 and the collar 16, the rotation of the tension ring 18 in one direction causes the collar 16 to move in a direction away from the first leg member 12. This movement creates a larger space within the collar 16 through which the marking device 20 can be placed. Once the marking device 20 is adequately positioned, the user rotates the tension ring 18 in the opposite direction, moving the marking device 20 and the collar 16 back towards the first leg member 12.

While preferred embodiments of the invention have been shown and described, it will be clear to those skilled in the art that potential modifications can be made to the embodiments described above. For example, it may be possible to fixedly secure one of the two leg members to the head portion while still permitting the other leg member to rotatably engage the threaded post. Alternatively, a variety of connecting means, such as pins and screws, can be used in various places in the compass, while several types of mechanisms beside common gear teeth can be used to rotate the leg members relative to the threaded post. It will therefore be well understood by those in the art that modifications can be made to the above embodiment without departing from the invention in its broader aspects.

1. A device for describing an arc on a describing surface, comprising:
a head portion;
a first leg member having a first end and a second end, the first end rotatably engaged with the head portion;
a second leg member having a first end and a second end, the first end of the second leg member engaged with the head portion at a point different from the point at which the first leg member is coupled to the head portion;
a post member engageable with the first end of the first leg member; and
an adjusting member engageable with the post member, the adjusting member rotatable about an axis substantially perpendicular to the describing surface,
wherein the rotation of the adjusting member results in a corresponding movement in the post member, the movement of the post member causing a rotation of the first end of the first leg member relative to the second leg member.

2. The device of claim 1, further comprising:
a collar for holding a marking instrument, the collar coupled to one of the first leg member and the second leg member; and
an adjustable tension ring engaged with the collar, wherein the tension ring is adjusted to alter the orientation of the collar such that the marking instrument can be fastened within the collar.

3. The device of claim 2, wherein the collar is threadedly engaged with the tension ring.

4. The device of claim 3, further comprising a plurality of positioning members coupled to the same leg member as the collar, the plurality of positioning members arranged to restrain the movement of the marking member when the marking member is fastened within the collar.

5. The device of claim 1, wherein the first end of second leg member is rotatably engaged with the head portion and the post member, and wherein the rotation of the adjusting member results in a corresponding movement in the post member, the movement of the post member causing a rotation of the first end of the first leg member and the first end of the second leg member relative to each other.

6. The device of claim 5, wherein the adjusting member threadedly engages the post member.

7. The device of claim 1, wherein the head portion comprises a first half and a second half, and wherein the post member is positioned between the first half and the second half.

8. The device of claim 7, wherein the first half and the second half of the head portion each include a slot in which the adjusting mechanism is positioned.

9. The device of claim 5, wherein the first end of the first leg member and the first end of the second leg member including a plurality of gear teeth for engaging a plurality of teeth on the post member.

10. A compass, comprising:
a head portion;
first and second leg members each having a first end and a second end, the first end of the first leg member and the first end of the second leg members rotatably engaged with the head portion at different locations on the head portion;
a post member meshedly engaged with the first end of the first and second leg members; and
an adjusting wheel threadedly engaged with the post member, the adjusting member rotatable about an axis substantially perpendicular to a marking surface,
wherein the rotation of the adjusting member results in a corresponding movement in the post member, the movement of the post member causing a rotation of the first end of the first leg member and the first end of the second leg member relative to each other.

11. The compass of claim 10, wherein the post member is positioned substantially within the head portion.

12. The compass of claim 11, wherein the adjusting wheel is positioned partially within the head portion.

13. The compass of claim 11, further comprising:
a collar for holding a marking instrument, the collar coupled adjacent to the second end of the first leg member; and
an adjustable tension ring threadedly engaged with the collar, wherein the tension ring is adjusted to alter the orientation of the collar such that the marking instrument can be fastened within the collar.

14. The compass of claim 13, wherein the first end of the first leg member and the first end of the second leg member include a plurality of gear teeth for engaging a plurality of teeth on the post member.

15. The compass of claim 14, further comprising a tip portion coupled to the second end of the second leg member for contacting a marking surface.

16. A marking instrument for describing an arc, comprising:
a head portion;
first and second leg members each having a first end and a second end, the first end of the first and second leg members coupled to the head portion at different locations on the head portion;
a post member positioned substantially within the head portion;
means for rotating the first end of the first leg member relative to the head portion;
an adjusting wheel positioned partially within the head portion and having a primary axis substantially perpendicular to a marking surface; and
means for adjustably engaging the adjusting wheel with the post member,
wherein the rotation of the adjusting member results in a corresponding movement in the post member, the movement of the post member causing a rotation of the first end of the first leg member relative to the second leg member.

17. The device of claim 16, further comprising means for rotating the first end of the second leg member relative to the head portion.

18. The device of claim 17, wherein the movement of the post member causes a rotation of both the first end of the first leg member and the first end of the second leg member relative to each other.

19. The device of claim 18, further comprising:
a collar for holding a marking instrument, the collar coupled adjacent to the second end of the first leg member; and
an adjustable tension ring threadedly engaged with the collar, wherein the tension ring is adjusted to alter the orientation of the collar such that the marking instrument can be fastened within the collar.

20. The device of claim 19, wherein a portion of the collar substantially surrounds a portion of the first leg member.
